(19) United States
(12) Patent Application Publication
(10) Pub. No.: US 2018/0139986 A1
(43) Pub. Date: May 24, 2018

(54) FADING REDUCED BEVERAGE

(71) Applicant: SUNTORY HOLDINGS LIMITED, Osaka-shi, Osaka (JP)

(72) Inventors: Akiko IZUMI, Kanagawa (JP); Soichiro URAI, Kanagawa (JP); Tomoyuki NISHIBORI, Kanagawa (JP); Koji NAGAO, Kanagawa (JP)

(73) Assignee: Suntory Holdings Limited, Osaka-shi, Osaka (JP)

(21) Appl. No.: 15/568,225

(22) PCT Filed: Feb. 3, 2017
(86) PCT No.: PCT/JP2017/003977

§ 371 Date: Oct. 20, 2017

(30) Foreign Application Priority Data
Mar. 31, 2016 (JP) 2016-072007

(51) Int. Cl. A23L 2/58; A23L 2/38; A23L 2/60

(52) U.S. Cl. CPC A23L 2/58; A23V 2002/00; A23L 2/60; A23L 2/38

(57) ABSTRACT

The present invention has an object to provide a beverage wherein fading of a caramel coloring is reduced. The present invention also has an object to provide a method for producing such a beverage and a method for reducing the caramel coloring fading in the beverage. The beverage meeting the following conditions (A) and (B): (A) a ratio of a content of RebD or RebM to a content of RebA is 0.45 or more, and (B) a caramel coloring is contained so that Lab values of the beverage are respectively L: 45 to 55, a: 10 to 20, and b: 25 to 35.

### TECHNICAL FIELD

The present invention relates to a beverage wherein the fading of a caramel coloring in the beverage is reduced.

### BACKGROUND ART

In order to address diversifying consumer needs, various beverages are developed and commercially available. Saccharides such as sucrose are components extremely ordinarily blended in beverages for the purposes of giving sweetness, and the like, but the influence of excess intake on health has been pointed out, and there are needs for low calorie beverages. Needs for naturally derived materials are also increasing. In order to meet these needs, naturally derived sweeteners having a high degree of sweetness compared with saccharides are attracting attention. Patent Literature 1 discloses a functional sweetener composition containing a vitamin, a high intensity sweetener, and a sweetness-improving composition.

### CITATION LIST

### Patent Literature

Patent Literature 1: National Publication of International Patent Application No. 2009-517043

### SUMMARY OF INVENTION

### Technical Problem

One of the natural sweeteners is a stevia extract, and the inventors of this application have conducted a study on the use of stevia extracts in beverages. In the course of the study, a problem was revealed that when a stevia extract is blended to a beverage containing a caramel coloring, the fading of the caramel coloring in the beverage further progresses. As natural sweeteners, Stevioside, Rebaudioside (hereinafter referred to as “Reb”), and the like as the sweet components of stevia extracts are known, and the details will be described later.

The present invention has been made in view of the above-described problem and has an object to provide a beverage wherein fading of a caramel coloring is reduced in spite of a stevia extract being blended.

### Solution to Problem

The present inventors conducted extensive studies to solve the above problem and surprisingly found that, of the stevia extracts, when a ratio of a content of RebA to a content of RebD and/or RebM is adjusted to a predetermined range, the fading of a caramel coloring in the beverage is reduced. Based on the finding, the present inventors completed the present invention.

(1) A beverage meeting the following conditions (A) and (B):
(A) a ratio of a content of RebD and/or RebM to a content of RebA is 0.45 or more, and
(B) a caramel coloring is contained so that Lab values of the beverage are respectively L: 45 to 55, a: 10 to 20, and b: 25 to 35.
(2) The beverage according to (1), wherein the ratio of the condition (A) is 2.2 to 2.8.
(3) The beverage according to (1) or (2), wherein the caramel coloring is caramel IV.
(4) The beverage according to any one of (1) to (3), having Brix (in terms of sucrose) of the beverage is 1 to 15.
(5) A method for reducing fading of a caramel coloring in a beverage, the method comprising the steps of:
(A) adjusting a ratio of a content of RebD and/or RebM to a content of RebA to be 0.45 or more, and
(B) adding a caramel coloring so that Lab values of the beverage are respectively L: 45 to 55, a: 10 to 20, and b: 25 to 35.
(6) A beverage wherein fading of a caramel coloring is reduced, the beverage meeting the following conditions (A) to (E):
(A) a ratio of a content of RebM to a content of RebA is 2.4 or more,
(B) Lab values of the beverage are respectively L: 45 to 55, a: 10 to 20, and b: 25 to 35,
(C) a content of the caramel coloring is 0.01 to 0.5 wt % (w/w),
(D) Brix of the beverage is 1 to 15, and
(E) a ratio of a difference in Lab values between after light irradiation at 55000 lux for 15 hours and 15 minutes is carried out and before the light irradiation is carried out: ((L2−L1)²+(a2−a1)²+(b2−b1)²)^{1/2}
(wherein
L1 is an L value before the light irradiation, L2 is an L value after the light irradiation,
a1 is an a value before the light irradiation, a2 is an a value after the light irradiation,
b1 is a b value before the light irradiation, b2 is a b value after the light irradiation) to a difference in Lab values between before and after the light irradiation of a control (an aqueous solution containing a caramel coloring at a concentration of 2960 mg/L) is 0.99 to 1.01.
(7) The beverage according to (6), wherein the caramel coloring is caramel IV.
(8) The beverage according to (6) or (7), wherein a content of RebA in the beverage is 1 to 30 ppm.
(9) The beverage according to any one of (6) to (8), wherein a content of RebM in the beverage is 10 to 550 ppm.
(10) The beverage according to any one of (6) to (9), wherein Lab values of the beverage are respectively L: 47 to 53, a: 16 to 20, and b: 29 to 34,
(11) A method for reducing fading of a caramel coloring in the beverage, the method comprising the steps of:
(A) adjusting a ratio of a content of RebM to a content of RebA to be 2.4 or more, and
(B) adjusting Lab values of the beverage to be respectively L: 45 to 55, a: 10 to 20, and b: 25 to 35,
(C) adjusting a content of a caramel coloring to be 0.01 to 0.5 wt % (w/w), and
(D) adjusting Brix of the beverage to be 1 to 15.

Embodiments of the present invention provide a beverage meeting the following conditions (A) and (B):
(A) a ratio of a content of RebD and/or RebM to a content of RebA is 0.45 or more, and (B) a caramel coloring is contained so that Lab values of the beverage are respectively L: 45 to 55, a: 10 to 20, and b: 25 to 35, but not limited thereto.

### Advantageous Effects of Invention

According to the present invention, a beverage wherein fading of a caramel coloring is reduced can be provided.

### BRIEF DESCRIPTION OF DRAWINGS

FIG. 1 is a graph showing caramel coloring fading reduction effects when a ratio of a content of RebD to a content of RebA is adjusted. For example, D0 means a beverage sample in which RebD is not contained but only RebA is contained (that is, 100%). Additionally, D70 means a beverage sample containing 70% of RebD and 30% of RebA in a Brix ratio in terms of sucrose.

FIG. 2 is a graph showing caramel coloring fading reduction effects when a ratio of a content of RebM to a content of RebA is adjusted. For example, M100 means a beverage sample in which RebA is not contained but only RebM is contained (that is, 100%). Additionally, M50 means a beverage sample containing 50% of each of RebA and RebM in a Brix ratio in terms of sucrose.

### DESCRIPTION OF EMBODIMENTS

The beverage according to the embodiment of the present invention will be described below.

The beverage according to the embodiment of the present invention is a beverage meeting the following conditions (A) and (B):
(A) a ratio of a content of RebD and/or RebM to a content of RebA is 0.45 or more, and
(B) a caramel coloring is contained so that Lab values of the beverage are respectively L: 45 to 55, a: 10 to 20, and b: 25 to 35.

Reb (Rebaudioside) is known as a sweet component contained in a stevia extract. The stevia extract is obtained by extraction from stevia dry leaves and purification. A stevia is an Asteraceae perennial plant native to Paraguay in South America, and its scientific name is Stevia Rebaudiana Bertoni. The stevia comprises a component having about 300 times or more the sweetness of sugar and therefore is grown in order to extract this sweet component and use it as a natural sweetener. As Reb, RebA, RebB, RebC, RebD, and RebE are known. Further, recently, the presence of various glycosides such as RebM described in National Publication of International Patent Application No. 2012-504552 have been reported. Among various Rebs, RebA is evaluated as a sweetener having a high degree of sweetness and good sweetness and widely used. In the embodiment of the present invention, as stevia extracts, RebA, RebD, and RebM are focused. RebA, RebD, and RebM are available on the market and can also be synthesized by an organic chemical method. Alternatively, using a stevia extract as a starting raw material, RebA, RebD, and RebM can also be separated and purified. For example, RebA can be purified according to the method described in National Publication of International Patent Application No. 2009-517043, RebD can be purified according to the method described in U.S. Pat. No. 8,414,949, and RebM can be purified according to the method described in Foods 2014, 3(1), 162-175; doi: 10.3390/foods3010162. RebA, RebD, and RebM may be analyzed by any method and can be analyzed, for example, by a high performance liquid chromatograph (HPLC) set under conditions described in National Publication of International Patent Application No. 2012-504552. RebA, RebD, and RebM are analyzed herein by the method, unless otherwise described.

In the beverage according to the embodiment of the present invention, RebA and RebD and/or RebM are blended at a particular content ratio. Specifically, a ratio of a content of RebD and/or RebM to a content of RebA ((RebD and/or RebM)/RebA) is 0.45 or more. When such a ratio is less than 0.45, the effect to reduce the fading of a caramel coloring in the beverage tends to be diminished. Note that the “RebD and/or RebM” used herein means that both of RebD and RebM may be contained, or either one of RebD or RebM may be contained. Thus, the above content ratio can respectively be any of
(i) the ratio of a total content of RebD and RebM to a content of RebA,
(ii) the ratio of a content of RebD to a content of RebA, and
(iii) the ratio of a content of RebM to a content of RebA.

In the beverage according to the embodiment of the present invention, the ratio of a content of RebD and/or RebM to a content of RebA is preferably 1 or more, more preferably 2.4 or more. Such a ratio may be a further greater numerical value and, for example, 5 or more, 10 or more, 30 or more, 50 or more, 70 or more, or 100 or more. For RebD, a further greater numerical value may be mentioned, and the ratio of a content of RebD to a content of RebA may be, for example, 150 or more, 200 or more, or 250 or more. For RebM, the ratio of a content of RebM to a content of RebA can be, for example, 5 or more, 10 or more, 30 or more, 50 or more, or 70 or more.

The ratio of a content of RebD and/or RebM to a content of RebA is not particularly limited but, for example, 500 or less, 400 or less, or 300 or less. For RebD, the ratio of a content of RebD to a content of RebA can be, for example, 500 or less, 400 or less, or 300 or less. For RebM, a further smaller numerical value may be mentioned, and the ratio of a content of RebM to a content of RebA may be, for example, 200 or less, 150 or less, 100 or less, 90 or less, or 80 or less. As an embodiment, the ratio of a content of RebD and/or RebM to a content of RebA is, for example, 20 or less, preferably 9.5 or less, more preferably 4.2 or less. The ratio of a content of RebD and/or RebM to a content of RebA ranges preferably from 1 to 9.5, more preferably 2.2 to 2.8, but not limited thereto.

The above content ratios herein can be converted to a Brix ratio (in terms of sucrose). RebA has 300 times, RebD has 285 times and RebM has 285 times the degree of sweetness of sucrose. The Brix ratio (in terms of sucrose) can be calculated from a degree of sweetness of Reb as compared to sucrose and a content of Reb. Accordingly, the Brix ratio in terms of sucrose can be calculated using a numerical value of 300 times a content of RebA, a numerical value of 285 times a content of RebD, and a numerical value of 285 times a content of RebM. Conversely, the above mass ratios can also be determined from the Brix ratio (in terms of sucrose) based on this calculation method. Note that the amount equivalent to Brix 1 in terms of sucrose is 33.3 ppm for RebA, 35.1 ppm for RebD, and 35.1 ppm for RebM.

The inventors of this application found for the first time that RebA is involved in the progress of the caramel coloring fading on beverages containing stevia extracts. The embodiment of the present invention, in the caramel coloring-containing beverages, is to reduce the fading of such a coloring by decreasing a content of RebA as the stevia extract. The content of RebA in the beverage is, for example, 350 ppm or less, preferably 300 ppm or less, more preferably 250 ppm or less, 200 ppm or less, 150 ppm or less, 100 ppm or less, 50 ppm or less, or 30 ppm or less, but not limited thereto. RebA may be contained in the beverage to a degree that sweetness is slightly felt and, for example, at 1 ppm or more, preferably 5 ppm or more, more preferably 10 ppm or more. The “ppm” used herein means weight/volume (w/v) ppm, unless otherwise described.

As described above, when a content of RebA as the stevia extract in the beverage is simply decreased, the sweetness derived from the stevia extract cannot be sufficiently imparted to the beverage. The inventors of this application found for the first time that RebD and/or RebM makes it harder than RebA for the fading of a caramel coloring to progress. Specifically, the embodiment of the present invention responds to the issue of the fading in the caramel coloring-containing beverages by replacing RebA with RebD and/or RebM as the stevia extract while enabling to impart substantial sweetness derived from the stevia extract. In the beverage in the embodiment of the present invention, the content of RebD or RebM can be the amount required as the substitute of RebA. As described above, the beverage in the embodiment of the present invention can contain RebD and RebM singly or in combination. When RebD or RebM is singly contained, the content of RebD or RebM in the beverage is not particularly limited but is, for example, 10 to 550 ppm, preferably 30 to 500 ppm, more preferably 50 to 500 ppm. When both RebD and RebM are contained, the total amount of RebD and RebM is not particularly limited but is, for example, 10 to 550 ppm, preferably 30 to 500 ppm, more preferably 50 to 500 ppm.

In the beverage according to the embodiment of the present invention, the degree of sweetness can be adjusted so that moderate sweetness can be felt, but not limited thereto. For such a degree of sweetness, for example, Brix (in terms of sucrose) of the beverage according to the embodiment of the present invention is 1 to 15. Such a Brix can be suitably set in accordance with the use condition of the beverage and set within a range from, for example, 3 to 13, or 7 to 13. Additionally, the Brix can be set within a low range or a high range and can be, in such an instance, for example, 5 or less (e.g., 1 to 5), 4 or less (e.g., 1 to 4), 3 or less (e.g., 1 to 3), 2 or less (e.g., 1 to 2), or 10 or more (e.g., 10 to 15), 11 or more (e.g., 11 to 15), 12 or more (e.g., 12 to 15), 13 or more (e.g., 13 to 15), 14 or more (e.g., 14 to 15). The Brix (in terms of sucrose) of the beverage according to the embodiment of the present invention may be adjusted only by the total content of RebA, RebD, and RebM, or may be adjusted as the total value of the entire sweeteners using a sweetener other than RebA, RebD, and RebM.

The beverage according to the embodiment of the present invention contains a caramel coloring. Here, as the caramel coloring, a known edible caramel coloring can be used. For example, a substance obtained by heat-treating an edible carbohydrate typified by sugar or glucose, one obtained by adding an acid or an alkali and heat-treating an edible carbohydrate, and the like can be used as the caramel coloring. In addition, a sugar contained in a fruit juice or a vegetable juice can also be caramelized and used, and in this case, the sugar can be caramelized by heat treatment, treatment with an acid or an alkali, or the like.

In the present invention, various classes of caramels such as caramel I, caramel II, caramel III and caramel IV can be used as the caramel coloring. Caramels of each class (I to IV) are classified based on the presence or absence of the treatment using a sulfurous acid compound and an ammonium compound at the time of producing a caramel coloring. Specifically, caramel I is the caramel coloring obtained by heat-treating an edible carbohydrate without using a sulfurous acid compound and an ammonium compound, caramel II is the caramel coloring obtained by heat-treating an edible carbohydrate without using an ammonium compound but using a sulfurous acid compound, caramel III is the caramel coloring obtained by heat-treating an edible carbohydrate without using a sulfurous acid compound but using an ammonium compound, and caramel IV is the caramel coloring obtained by heat-treating an edible carbohydrate using both of a sulfurous acid compound and an ammonium compound. In the beverage according to the embodiment of the present invention, caramel IV is preferably contained but not particularly limited thereto.

In the beverage according to the embodiment of the present invention, Lab values of the beverage are respectively L: 45 to 55, a: 10 to 20, and b: 25 to 35, and the beverage color can be adjusted in such a way that Lab values are to be such values. The above Lab values are preferably L: 47 to 53, a: 16 to 20, and b: 29 to 34. The Lab values of the beverage according to the embodiment of the present invention can be adjusted by the content of the caramel coloring. Specifically, the beverage according to the embodiment of the present invention can contain the caramel coloring so that Lab values of the beverage are respectively L: 45 to 55, a: 10 to 20, b: 25 to 35.

In the beverage according to the embodiment of the present invention, Lab values of the beverage can be measured using a measurement apparatus known by those skilled in the art. As a specific example, Lab values can be measured using a spectrophoto meter (colorimeter) SE6000, a product of Nippon Denshoku Industries Co., Ltd., as illustrated later in Test Examples, but not limited thereto.

Further, in the beverage according to the embodiment of the present invention, a content of the caramel coloring can be specified by the concentration. In that case, a content of the caramel coloring in the beverage can be 0.01 to 0.5 wt % (w/w), preferably 0.03 to 0.5 wt % (w/w), more preferably 0.05 to 0.4 wt % (w/w), but not limited thereto.

In the beverage according to the embodiment of the present invention, a method for measuring a content of the caramel coloring is not limited and the content can be measured using gas chromatography, HPLC, or the like. A method such as a quantitative method, a qualitative method, a confirmation testing method or a purity test method described in various official compendia may be suitably applied, or a method described in publication may be modified and used. The content can also be determined from the indication and description on a product or a product brochure, or a document concerning a factory order, a manufacturing record or an approval and license.

The beverage according to the embodiment of the present invention may further comprise components that can be used in foods and drinks, such as polyphenols such as catechins, extracts of plants, caffeine, cinnamaldehyde, and sweeteners (saccharides such as sugar and isomerized liquid sugars, and high intensity sweeteners such as aspartame, sucralose, and acesulfame K), perfumes, acidulants (citric acid, tartaric acid, malic acid, phosphoric acid, and lactic acid), colorants, fruit juices, fruit juice purees, milk, milk products, other flavors, and nutrient supplements (vitamins, calcium, minerals, and amino acids), as long as the components do not inhibit the effect of the present invention. These components may be blended singly or in combination of a plurality of these components in the beverage.

In the present invention, the kind of beverage is not particularly limited and may be any of carbonated beverages, non-carbonated beverages, alcoholic beverages, non-alcoholic beverages, energy drinks or functional beverages.

When the beverage according to the embodiment of the present invention is a carbonated beverage (that is, effervescent), the carbonation method is not particularly limited and carbonic acid gas may be produced by fermentation in the beverage or carbonic acid gas may be artificially injected into the beverage. When the carbonic acid gas is injected, the gas pressure at a liquid temperature of 20° C. can be, for example, 1 to 5 kgf/cm², preferably 2 to 5 kgf/cm², more preferably 3 to 5 kgf/cm². The carbonic acid gas can be added using a method known by those skilled in the art. The carbonic acid gas pressure in the beverage can be measured, for example, using a Kyoto Electronics Manufacturing Co., Ltd. gas volume analyzer GVA-500A.

The beverage according to the embodiment of the present invention can be filled into a container but not particularly limited thereto. For the container, a container of any form and material can be used and may be, for example, a bottle, a can, a barrel, or a PET bottle. Additionally, the method for filling the beverage into a container is also not particularly limited.

According to another aspect in the embodiment of the present invention, a method for reducing the fading of a caramel coloring in the beverage is provided. The method of the present invention is a method for reducing the fading of a caramel coloring in the beverage, the method comprising the steps of:
(A) adjusting a ratio of a content of RebD and/or RebM to a content of RebA to be 0.45 or more, and
(B) adding a caramel coloring so that Lab values of the beverage are respectively L: 45 to 55, a: 10 to 20, and b: 25 to 35.

In the method according to the embodiment of the present invention, RebA, RebD, and RebM can be blended in the beverage so that the content in the beverage is to be the amount as described above, but not limited thereto. Further, in the method of the present invention, the caramel coloring can also be blended in the beverage so as to be the content as described above, but not limited thereto. The blending order of each component is not particularly limited and each component may be blended simultaneously. The method of the present invention can also include a step of blending the components and materials described above and a step of adjusting the contents thereof. In the method of the present invention, various elements such as the kind and content of the components in the beverage are as described above in the beverage of the present invention and thus obvious therefrom.

The method according to the embodiment of the present invention can reduce, in the beverages containing a caramel coloring, a degree of the fading of the caramel coloring.

### EXAMPLES

Hereinbelow, details of the present invention are specifically described with reference to Test Examples and Examples. The following description only intends to facilitate understanding of the present invention but does not intend to limit the scope of the present invention.

Beverage samples were prepared as follows to examine degrees of the fading of the caramel coloring in the beverages.

First, caramel IV (Z-80 (Semba Tohka Industries Co., Ltd.)) used as the caramel coloring was added to pure water so that a concentration thereof was 2960 mg/L. Next, RebA, RebD and RebM were added to the obtained caramel coloring-containing solution so that the amounts blended were as shown in the table below. As controls for correcting Lab measured values, caramel coloring-containing solutions to which RebA, RebD and RebM were not added were used.

TABLE 1

| Sample name | | D0 | D3 | D50 | D70 | D100 | M0 | M30 | M50 | M70 | M100 |
|---|---|---|---|---|---|---|---|---|---|---|---|
| Content (ppm) | RebA | 33.3 | 23.3 | 16.7 | 10.0 | 0 | 33.3 | 23.3 | 16.7 | 10.0 | 0 |
| | RebD | 0 | 10.5 | 17.5 | 24.6 | 35.1 | 0 | 0 | 0 | 0 | 0 |
| | RebM | 0 | 0 | 0 | 0 | 0 | 0 | 10.5 | 17.5 | 24.6 | 35.1 |
| Brix ratio in | RebA | 100 | 70 | 50 | 30 | 0 | 100 | 70 | 50 | 30 | 0 |
| terms of sucrose | RebD | 0 | 30 | 50 | 70 | 100 | — | — | — | — | — |
| | RebM | — | — | — | — | — | 0 | 30 | 50 | 70 | 100 |

Lab values (that is, L, a and b values) of the beverage samples and the control samples for correcting Lab measured values were measured using a spectrophotometer (a product of Nippon Denshoku Industries Co., Ltd., SE6000).

Subsequently, each sample was irradiated with light at 55000 lux for 15 hours and 15 minutes in an artificial climate chamber (Nippon Medical & Chemical Instruments Co., Ltd., NC-410HH).

After the light irradiation, Lab values of the beverage samples and the control samples for correcting the Lab measured values were measured again using the above apparatus.

The differences in the Lab values of each beverage sample between before and after the light irradiation were determined, and relative values, when the difference in the Lab values of the control samples for correcting the Lab measured values between before and after the light irradiation was 1, were calculated respectively. Note that the difference in the Lab values was determined using the following formulae.
L value before the light irradiation: L1, L value after the light irradiation: L2
a value before the light irradiation: a1, a value after the light irradiation: a2
b value before the light irradiation: b1, b value after the light irradiation: b2
Difference in Lab values=((L2−L1)²+(a2−a1)²+(b2−b1)²)^{1/2}

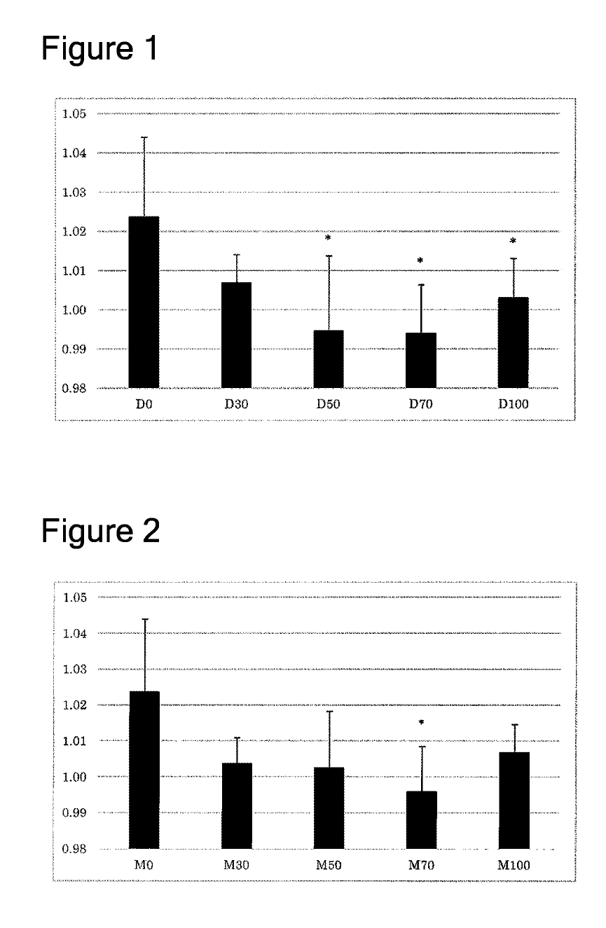

The results on examining the differences in the Lab values of each beverage sample are shown in the table below. Additionally, the results on the relative value of each beverage sample to the control sample for correcting the Lab measured values are shown in FIGS. 1 and 2.

TABLE 2

| | | Before irradiation | | | After irradiation | | | Difference in | |
|---|---|---|---|---|---|---|---|---|---|
| | No. | L | a | b | L | a | b | Lab values | Average |
| Control for | 1 | 51.46 | 18.1 | 33 | 66.41 | 10.91 | 39.69 | 17.89 | 17.52 |
| correction | 2 | 51.46 | 18.1 | 33 | 65.81 | 11.17 | 39.47 | 17.20 | |
| | 3 | 51.46 | 18.1 | 33 | 66.05 | 11.07 | 39.56 | 17.47 | |
| D0 (M0) | 1 | 51.37 | 18.2 | 32.99 | 66.42 | 10.88 | 39.69 | 18.03 | 17.93 |
| | 2 | 51.37 | 18.2 | 32.99 | 66.38 | 10.89 | 39.68 | 17.99 | |
| | 3 | 51.37 | 18.2 | 32.99 | 66.19 | 10.95 | 39.6 | 17.77 | |
| D30 | 1 | 51.7 | 18 | 33.12 | 66.7 | 10.69 | 39.76 | 17.96 | 17.63 |
| | 2 | 51.7 | 18 | 33.12 | 66.11 | 10.97 | 39.56 | 17.28 | |
| | 3 | 51.7 | 18 | 33.12 | 66.45 | 10.83 | 39.69 | 17.67 | |
| D50 | 1 | 51.76 | 17.97 | 33.17 | 66.26 | 10.86 | 39.61 | 17.39 | 17.43 |
| | 2 | 51.76 | 17.97 | 33.17 | 66.52 | 10.81 | 39.7 | 17.66 | |
| | 3 | 51.76 | 17.97 | 33.17 | 66.17 | 10.97 | 39.58 | 17.26 | |
| D70 | 1 | 51.71 | 18.01 | 33.15 | 66.39 | 10.86 | 39.66 | 17.58 | 17.43 |
| | 2 | 51.71 | 18.01 | 33.15 | 66.08 | 10.99 | 39.55 | 17.23 | |
| | 3 | 51.71 | 18.01 | 33.15 | 66.31 | 10.86 | 39.62 | 17.50 | |
| D100 | 1 | 51.57 | 18.1 | 33.1 | 66.14 | 10.99 | 39.59 | 17.46 | 17.58 |
| | 2 | 51.57 | 18.1 | 33.1 | 66.22 | 10.94 | 39.61 | 17.56 | |
| | 3 | 51.57 | 18.1 | 33.1 | 66.36 | 10.85 | 39.63 | 17.72 | |
| M30 | 1 | 51.5 | 17.97 | 33 | 66.34 | 10.83 | 39.62 | 17.75 | 17.58 |
| | 2 | 51.5 | 17.97 | 33 | 66.34 | 10.78 | 39.61 | 17.77 | |
| | 3 | 51.5 | 17.97 | 33 | 65.91 | 11.08 | 39.48 | 17.24 | |
| M50 | 1 | 51.66 | 17.96 | 33.1 | 66.52 | 10.76 | 39.69 | 17.78 | 17.56 |
| | 2 | 51.66 | 17.96 | 33.1 | 66.15 | 10.93 | 39.56 | 17.35 | |
| | 3 | 51.66 | 17.96 | 33.1 | 66.32 | 10.89 | 39.63 | 17.54 | |
| M70 | 1 | 51.67 | 17.97 | 33.11 | 66.23 | 10.91 | 39.59 | 17.43 | 17.43 |
| | 2 | 51.67 | 17.97 | 33.11 | 66.33 | 10.85 | 39.64 | 17.56 | |
| | 3 | 51.67 | 17.97 | 33.11 | 66.11 | 10.97 | 39.56 | 17.29 | |
| M100 | 1 | 51.6 | 18 | 33.07 | 66.29 | 10.91 | 39.63 | 17.58 | 17.63 |
| | 2 | 51.6 | 18 | 33.07 | 66.18 | 10.92 | 39.56 | 17.46 | |
| | 3 | 51.6 | 18 | 33.07 | 66.52 | 10.78 | 39.71 | 17.86 | |

As shown in FIGS. 1 and 2, the degree of the fading of the caramel coloring was reduced by replacing a part or all of the content of RebA with RebD or RebM. Particularly, the degree of the fading of the caramel coloring was reduced when the Brix ratio in terms of sucrose of RebD or RebM to RebA ((RebD or RebM)/RebA) is 3/7 or more, that is, a mass ratio of 0.45 or more. Note that it was demonstrated that the D50, D70 and D100 beverage samples had reduced fading with statistically significant differences to the D0 (that is, the RebA ratio is 100%) beverage sample. Similarly, it was demonstrated that the M70 beverage sample had reduced fading with statistically significant difference to the M0 (that is, the RebA ratio is 100%) beverage sample.

Further, as for RebM, it is revealed that the higher the ratio of RebM to RebA becomes, the smaller the entire number of moles becomes, as shown in the table below. however, despite the entire number of moles becoming smaller, the degree of the fading of the caramel coloring ended up being reduced when the RebM ratio became higher. This is presumably attributed to RebM being the compound of a larger molecular weight than RebA, thereby more blocking the caramel coloring from the light.

TABLE 3

| Sample name | | M0 | M30 | M50 | M70 | M100 |
|---|---|---|---|---|---|---|
| Content | RebA | 33.3 | 23.3 | 16.7 | 10 | 0 |
| (ppm) | RebM | 0 | 10.5 | 17.5 | 24.6 | 35.1 |
| Content | RebA | 1.72E−06 | 1.20E−06 | 8.63E−07 | 5.17E−07 | 0 |
| (mol) | RebM | 0 | 4.07E−07 | 6.78E−07 | 9.53E−07 | 1.36E−06 |

| | | | | | |
|---|---|---|---|---|---|
| Total (mol) | 1.72E−06 | 1.61E−06 | 1.54E−06 | 1.47E−06 | 1.36E−06 |

1. (canceled)

2. (canceled)

3. (canceled)

4. (canceled)

5. A method of inhibiting fading of caramel color in a liquid comprising caramel color and Reb A, comprising:
adding
caramel color to obtain Lab values as follows: L: 45-55, a: 10-20, and b:25-35; and
RebD and/or Reb M in a ratio to the Reb A of 0.45-2.8
to a liquid so that fading of the liquid is inhibited compared to the same liquid not comprising Reb A.

6. The method according to claim 5, wherein the ratio of RebD and/or RebM to RebA is 2.2 to 2.8.

7. The method according to claim 6, wherein the liquid is a beverage.

8. The method according to claim 7, wherein the beverage has a degree Brix in terms of sucrose of 1 to 15.

9. A beverage comprising caramel color, RebA, and one or both of RebD and/or RebM, wherein the beverage comprises caramel color sufficient to obtain Lab values of the beverage of L1: 45 to 55, a1: 10 to 20, and b1: 25 to 35; and comprises a ratio of RebD and/or RebM to RebA of 0.45-2.8,
wherein, when the beverage is exposed to light at 55000 lux for 15 hours 15 minutes, the resulting composition has Lab values of L2, a2, and b2; and
ΔLab<17.93, where ΔLab is calculated as ((L1−L2)²+(a1−a2)²+(b1−b2)²)^{1/2}.

10. The beverage according to claim 9, which has a degree Brix in terms of sucrose of 1 to 15.

11. A beverage in which fading of a caramel coloring is reduced, the beverage meeting the following conditions (A) to (E):
(A) a ratio of a content of RebD and/or RebM to a content of RebA is 0.45-2.8,
(B) Lab values of the beverage are respectively L: 45 to 55, a: 10 to 20, and b: 25 to 35,
(C) a content of the caramel coloring is 0.01 to 0.5 wt % (w/w),
(D) a degree Brix in terms of sucrose of the beverage is 1 to 15, and
(E) a ΔLab ratio between the beverage and a control sample of 0.99 to 1.01, wherein the ΔLab is based on measurements before and after light irradiation at 55000 lux for 15 hours and 15 minutes and is calculated as ((L2−L1)²+(a2−a1)²+(b2−b1)²)^{1/2} wherein
L1 is an L value before the light irradiation, L2 is an L value after the light irradiation,
a1 is an a value before the light irradiation, a2 is an a value after the light irradiation,
b1 is a b value before the light irradiation, b2 is a b value after the light irradiation and the control is an aqueous solution containing a caramel coloring at a concentration of 2960 mg/L.

12. The beverage according to claim 11, wherein the ratio of RebD and/or RebM to RebA is 2.2 to 2.8.
